(19) United States
(12) Patent Application Publication
(10) Pub. No.: US 2013/0332308 A1
(43) Pub. Date: Dec. 12, 2013

(54) METHOD FOR RECOMMENDING A GIFT TO A SENDER

(71) Applicants: Lee Linden, San Francisco, CA (US); Benjamin Lewis, San Francisco, CA (US)

(72) Inventors: Lee Linden, San Francisco, CA (US); Benjamin Lewis, San Francisco, CA (US)

(73) Assignee: FACEBOOK, INC., Menlo Park, CA (US)

(21) Appl. No.: 13/684,089

(22) Filed: Nov. 21, 2012

Related U.S. Application Data
(60) Provisional application No. 61/562,254, filed on Nov. 21, 2011.
(60) Provisional application No. 61/641,744, filed on May 2, 2012.

(51) Int. Cl. G06Q 30/06; G06Q 50/00

(52) U.S. Cl. CPC G06Q 30/0631; G06Q 50/01
USPC 705/26.7

(57) ABSTRACT

One variation of the method includes: receiving a set of communications from multiple users, the set of communications directed to a recipient through a social networking system; identifying a gift-appropriate event of the recipient based on the set of communications; determining an intent of a sender to respond to the gift-appropriate event of the recipient based on an incomplete electronic note drafted by the sender, within the social networking system, and designating the recipient; selecting a gift for the recipient in response to the determined intent of the sender; and prior to transmission of the note to the recipient, displaying a recommendation to the sender, the recommendation including a suggestion to purchase the gift for the recipient.

### CROSS-REFERENCE TO RELATED APPLICATIONS

This application claims the benefit of U.S. Provisional Application No. 61/562,254, filed on 21 Nov. 2011 and titled “Method for Generating Gift-Appropriate Event Notifications,” which is incorporated in its entirety herein by this reference.

This application further claims the benefit of U.S. Provisional Application No. 61/641,744, filed on 2 May 2012 and titled “Method for Selling a Product to a Sender,” which is incorporated in its entirety herein by this reference.

This application is related to: U.S. patent application Ser. No. 13/615,289, filed on 13 Sep. 2012 and titled “Method for Enabling a Gift Transaction”; U.S. patent application Ser. No. 12/978,265, filed on 23 Dec. 2010 and titled “Contextually Relevant Affinity Prediction in a Social Networking System”; U.S. patent application Ser. No. 13/239,340, filed on 21 Sep. 2011 and titled “Structured Objects and Actions on a Social Networking System”; U.S. patent application Ser. No. 12/508,521, filed on 23 Jul. 2009 and titled “Markup Language for Incorporating Social Networking Information by an External Website”; U.S. Pat. No. 8,250,145, issued on 21 Aug. 2012 and titled “Personalizing a Web Page Outside of a Social Networking System with Content from the Social Networking System”; U.S. patent application Ser. No. 12/969,368, filed on 15 Dec. 2010 and titled “Comment Plug-In for Third Party System”; and U.S. patent application Ser. No. 13/167,702, filed on 24 Jun. 2011 and titled “Suggesting Tags in Status Messages Based On Social Context”, all of which are incorporated in their entirety by this reference.

### TECHNICAL FIELD

This invention relates generally to the field of e-commerce, and more specifically to a new and useful method for recommending a gift to a sender in the field of e-commerce.

### BACKGROUND

People commonly use social networking systems to access and respond to certain life events of friends and family, such as birthdays, weddings, holidays, competitions, births, new jobs, etc. Sometimes, these life events are appropriate gifting events. However, many social networks fail to link gifting opportunities to such gifting events, and users interested in gifting must navigate to other gifting venues in order to select a gift for a friend or family member. This can lower overall gifting rates and/or siphon users away from a social networking system.

### BRIEF DESCRIPTION OF THE FIGURES

FIG. 1 is a flowchart representation of a method of one embodiment;

FIG. 2 is a flowchart representation of a variation of the method;

FIG. 3 is a flowchart representation of a variation of the method;

FIG. 4 is a graphical representation of a sender interface in accordance with a variation of the method;

FIG. 5 is a graphical representation of a sender interface in accordance with a variation of the method;

FIG. 6 is a graphical representation of a recipient interface in accordance with a variation of the method;

FIG. 7 is a block diagram of a system environment for a social networking system; and

FIG. 8 is a block diagram of a system architecture of the social networking system;

FIG. 9 is a flowchart representation of a variation of the method;

FIG. 10 is a flowchart representation of a variation of the method;

FIG. 11 is a flowchart representation of a variation of the method; and

FIG. 12 is a flowchart representation of a Block in accordance with one variation of the method.

### DESCRIPTION OF THE EMBODIMENTS

The following description of the embodiments of the invention is not intended to limit the invention to these embodiments, but rather to enable any person skilled in the art to make and use this invention.

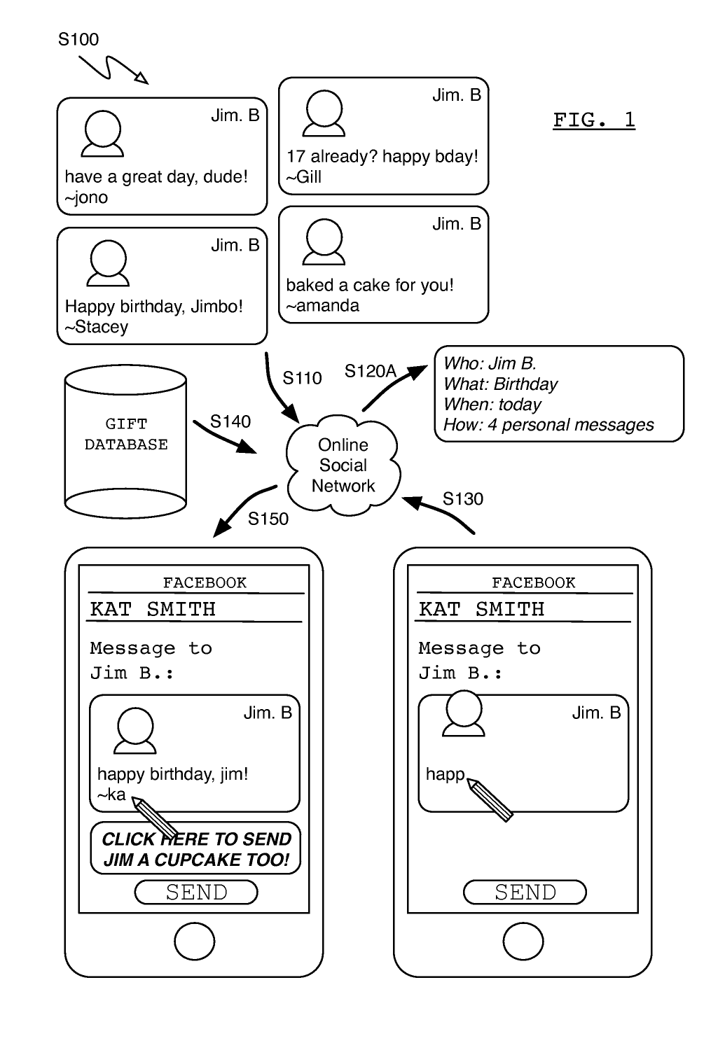

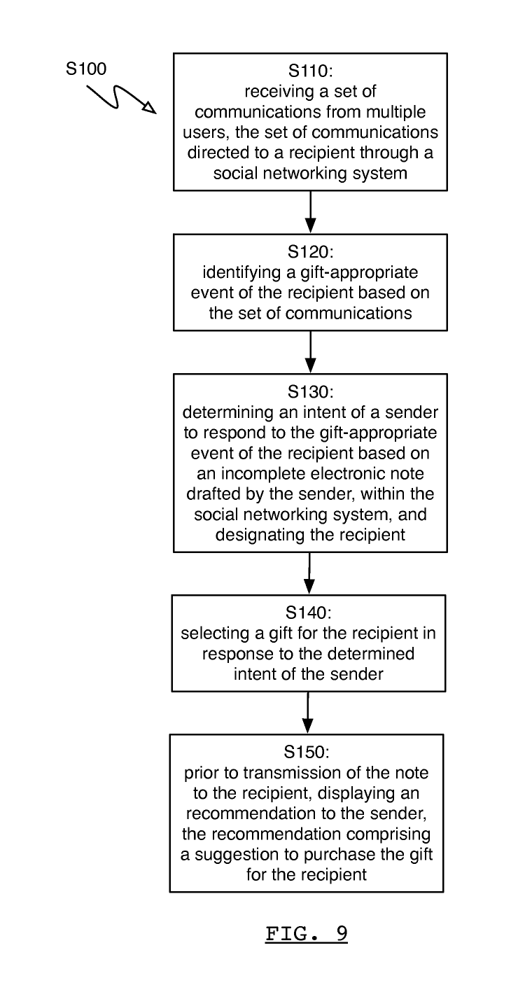

As shown in FIGS. 1 and 9, a method S100 for recommending a gift to a sender includes: receiving a set of communications from a set of users, the set of communications directed to a recipient through a social networking system in Block S110; identifying a gift-appropriate event of the recipient based on the set of communications in Block S120A; determining an intent of a sender to respond to the gift-appropriate event of the recipient based on an incomplete electronic note drafted by the sender, within the social networking system, and designating the recipient in Block S130; selecting a gift for the recipient in response to the determined intent of the sender in Block S140; and, prior to transmission of the note to the recipient, displaying a recommendation to the sender in Block S150, the recommendation including a suggestion to purchase the selected gift for the recipient. In another embodiment, the electronic communication is entered into a system that is either internal or external to the social networking system.

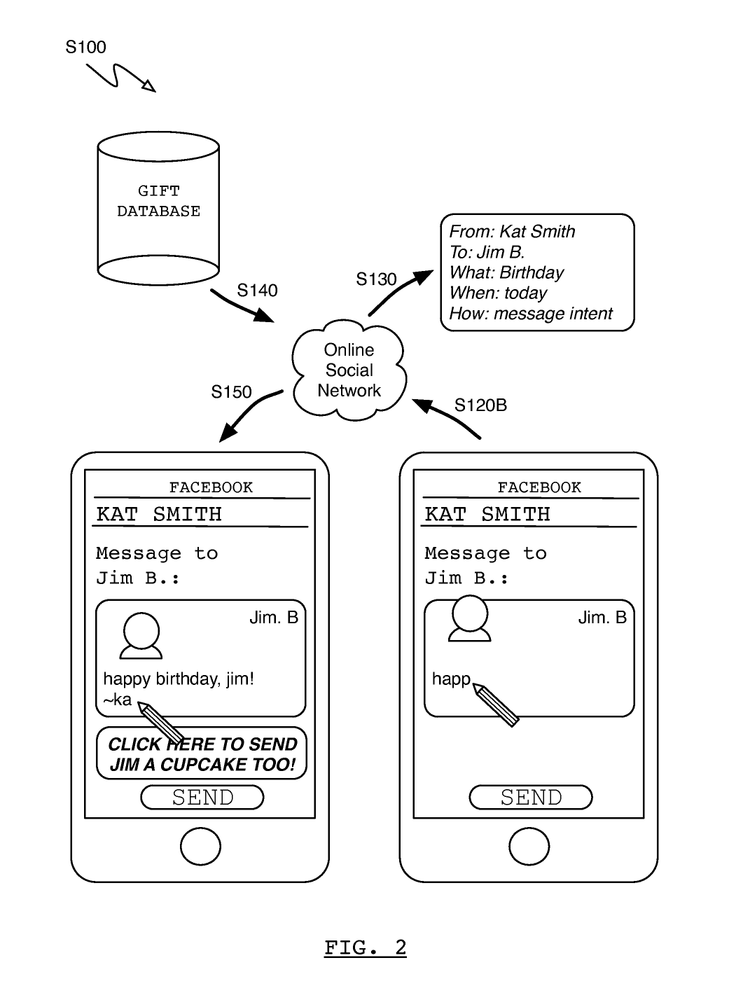

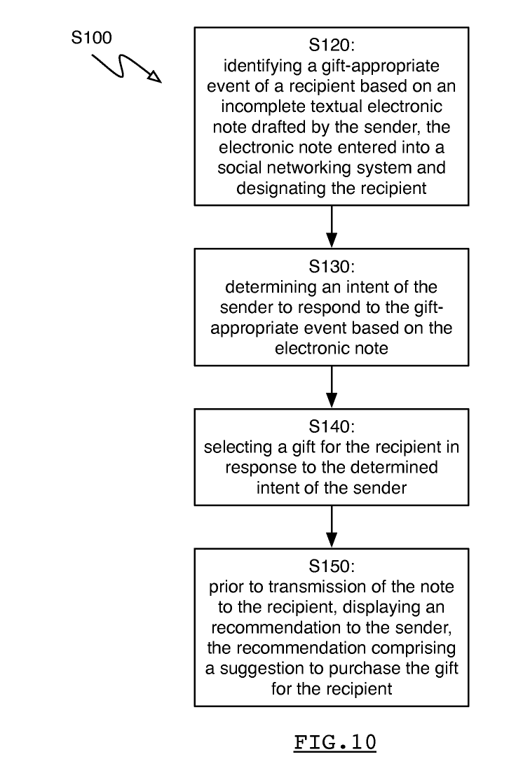

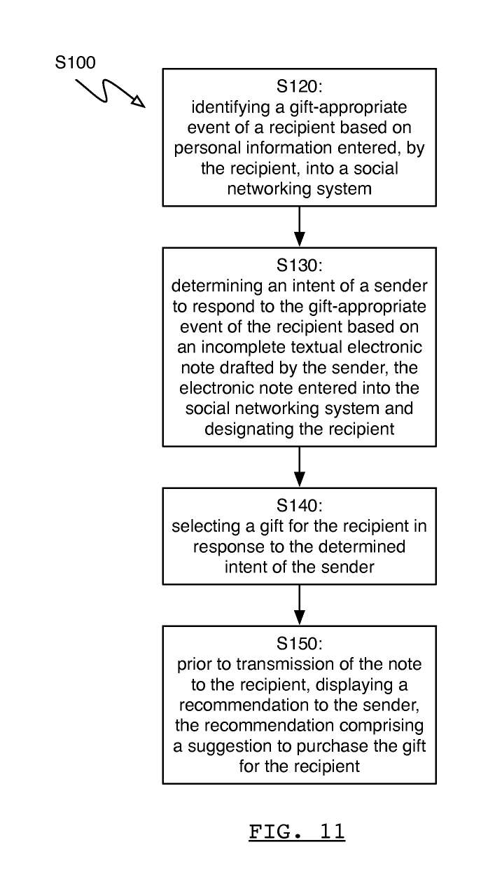

As shown in FIGS. 2 and 10, a first variation of the method S100 includes: identifying a gift-appropriate event of a recipient based on an incomplete textual electronic note drafted by the sender in Block S120B, the electronic note entered into a social networking system (or an embedded widget, a social plug-in, programmable logic or code snippet in a third party web page) and designating the recipient; determining an intent of the sender to respond to the gift-appropriate event based on the electronic note in Block S130; selecting a gift for the recipient in response to the determined intent of the sender in Block S140; and, prior to transmission of the note to the recipient, displaying a recommendation to the sender in Block S150, the recommendation including a suggestion to purchase the selected gift for the recipient.

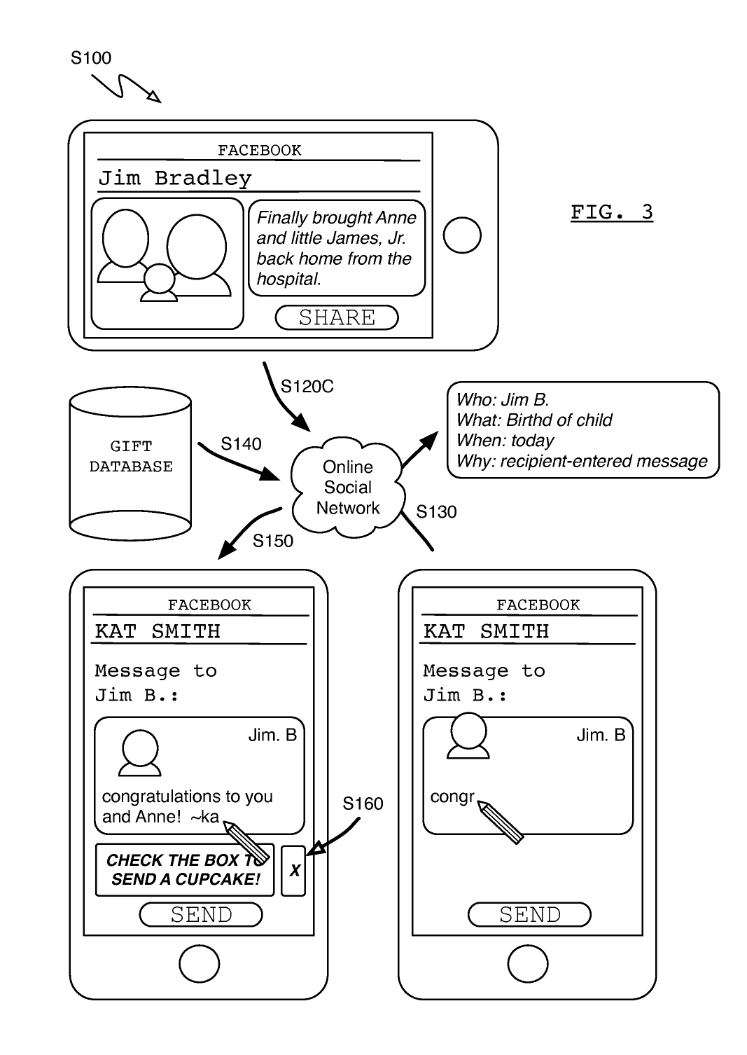

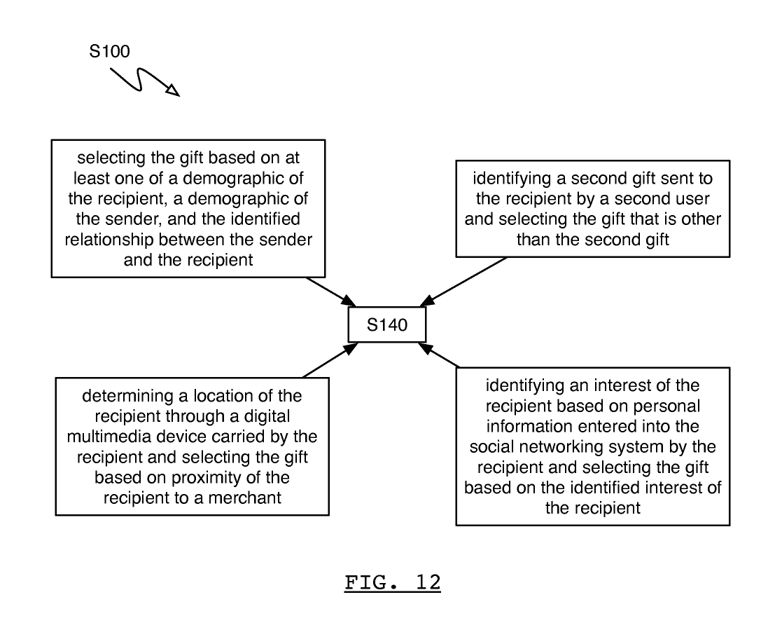

As shown in FIGS. 3 and 11, a second variation of the method S100 includes: identifying a gift-appropriate event of a recipient based on personal information entered, by the recipient, into a social networking system (or an embedded widget, a social plug-in, programmable logic or code snippet in a third party web page) in Block S120C; determining an intent of a sender to respond to the gift-appropriate event of the recipient based on an incomplete textual electronic note drafted by the sender in Block S130, the electronic note entered into the social networking system (or an embedded widget, a social plug-in, programmable logic or code snippet in a third party web page) and designating the recipient; selecting a gift for the recipient in response to the determined intent of the sender in Block S140; and prior to transmission of the note to the recipient, displaying a recommendation to the sender in Block S150, the recommendation including a suggestion to purchase the selected gift for the recipient.

The method S100 functions to determine an intent of a sender to respond to a gift-appropriate event of a recipient based on a note drafted by the sender and to advertise a selected gift to the sender prior to completion of the note to the recipient. By identifying a potentially altruistic moment of the sender, as suggested by the sender's initial response to the gift-appropriate event, the method S100 can target a recommendation for a gift to the sender at a particular moment in which the sender may be particularly likely to make a purchase for the recipient. The method S100 identifies the gift-appropriate event through analysis of the set of communications previously sent to the recipient by other users, and the first and second variations of the method S100 identify the gift-appropriate event based on content of the sender's note and based on information previously entered into the social networking system by the recipient, respectively. The method S100 can identify a recent recipient event and determine the event to be a relevant gifting opportunity for the sender given various factors, such as sender-recipient relationship, sender or recipient demographic, sender or recipient interest, etc. The method S100 can therefore provide pinpoint, occasion-specific, sender-specific, recipient-specific recommending for a particular product and substantially seamlessly direct the sender toward purchase of the product for the recipient. A reference to the term “product” is not limited to physical goods but includes various types of goods and services, charity donations, gift cards, memberships of organizations, tickets to events, media including music, videos, movies, etc. The method S100 can thus define a particular need for a product (e.g., the gift-appropriate event), contextualize the need for the product (e.g., the needs of the recipient, social expectations), select the product (e.g., based upon the event or a demographic of the recipient and/or the user), and automatically inform the sender of the gift and gifting context without directing the sender away from his current task.

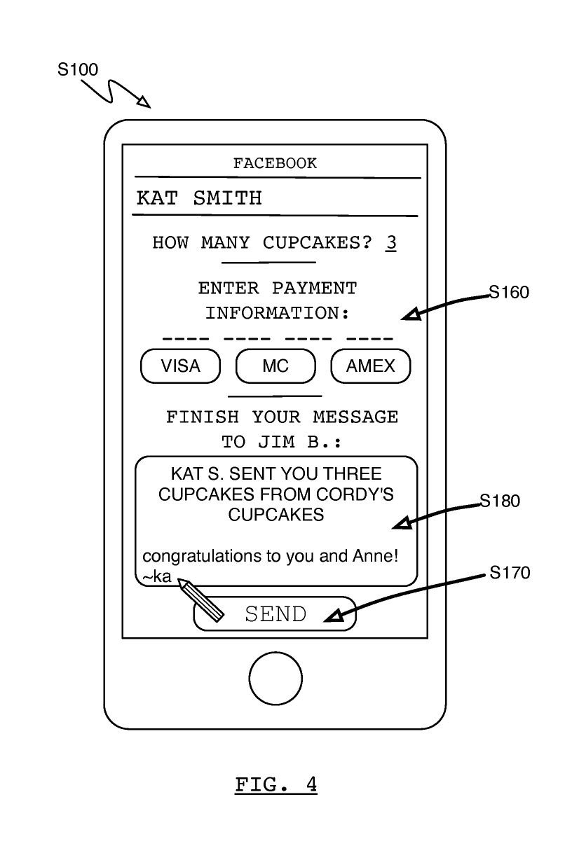

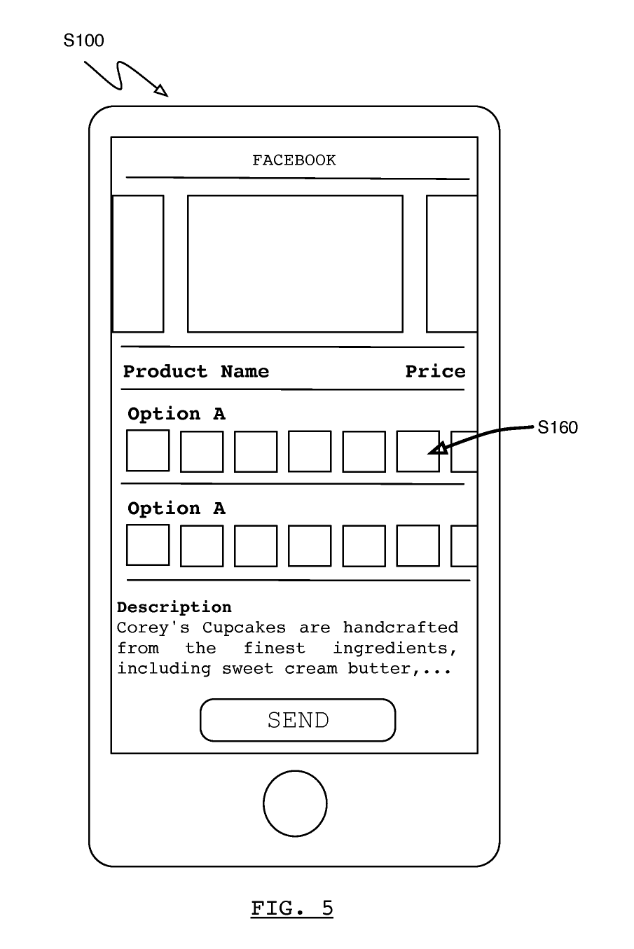

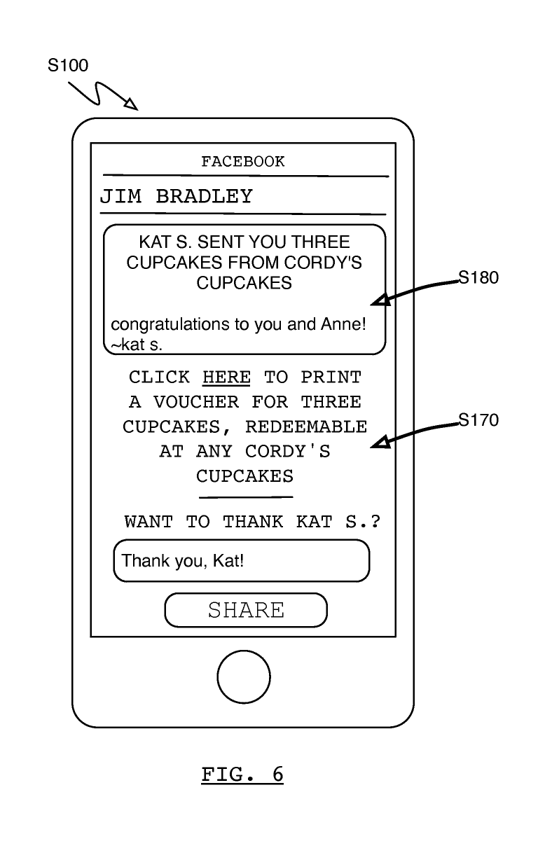

The method S100 can be implemented by a computer system, such as a gifting or recommending service that analyzes communications sent to a recipient in Block S120A, analyzes a note drafted by a sender in Block S130, selects a gift in Block S140, and recommends the selected gift in Block S150. The computer system can be a cloud-based computer (e.g., Amazon EC3), a mainframe computer system, a grid-computer system, or any other suitable computer system. The computer system can support a messaging platform for communicating messages between the recipient, the sender, and/or other users. For example, the computer system can support, distribute, and collect communications via a distributed network, such as over the Internet, wherein one or more processors throughout the distributed network implement one or more Blocks of the method S100. The computer system can also incorporate a sender-side interface (as shown in FIGS. 4 and 5) and a recipient-side interface (as shown in FIG. 6). The sender-side interface can incorporate a recommendation field, an input field in which the sender may draft the note, a payment field, and/or a link to complete a gift order for the recipient. The recipient may review the completed note, access a gift, and/or review a gift order through the recipient-side interface. Generally, the sender- and recipient-side interfaces can each be accessible through a web browser or through a native application executing on an electronic device, such as a laptop computer, a desktop computer, a tablet, a smartphone, a personal data assistant (PDA), a personal music player, etc. and can be either internal or external on or off a messaging platform of within the social networking system.

The method S100 can be implemented through a social networking system (e.g., Facebook) that enables communication between users, such as between users and a potential recipient. The social networking system can also contain relevant, user, sender, and/or recipient information (e.g., relationship statuses, demographic information, interests), track dates and/or occurrences of gift-appropriate events (e.g., birthdays, promotions, graduations, anniversaries), and/or track tangible and/or virtual gifts sent to the recipient by other users, such as according to privacy settings set by the sender, recipient, and/or users.

Additionally or alternatively, the method S100 can be implemented by an online dating network, a single-merchant online marketplace, an online merchant aggregator, or any other suitable online or brick-and-mortar venue that enables remote exchange of goods and/or services. The method S100 can also be implemented by an external messaging platform, such as an instant messaging service (e.g., GoogleChat, AOL Instant Messenger), a mobile messaging service (e.g., SMS text message), or an electronic card service (e.g., egreetings.com). However, the method S100 can be implemented by any other computer system, service, or network and can include any other interface to support submission and retrieval of messages, notes, and data for senders and recipients.

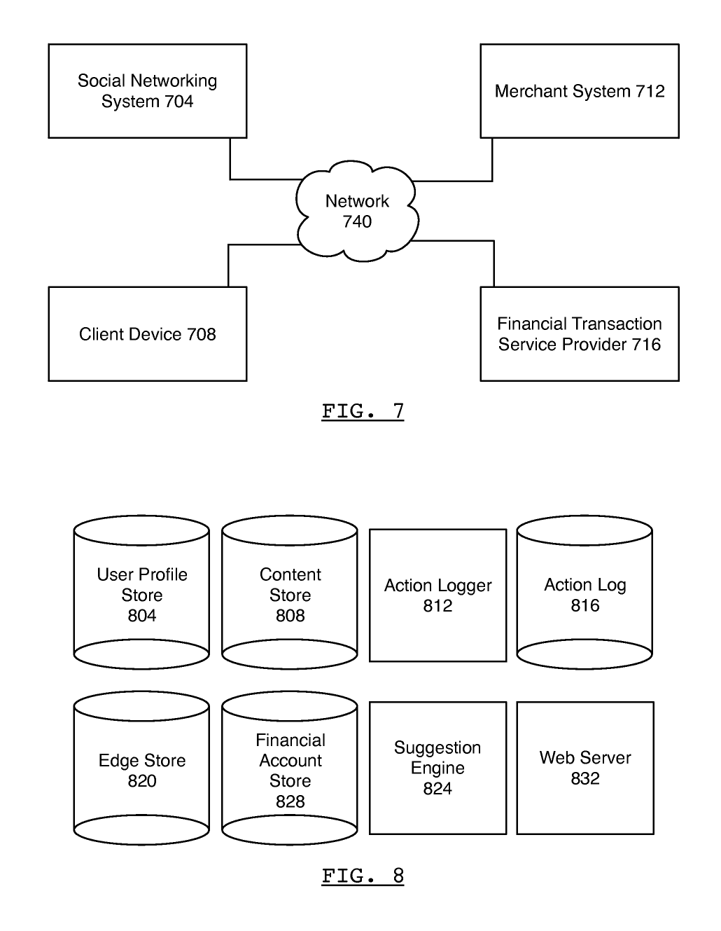

FIG. 7 is a block diagram of a system environment 100 for a social networking system 704. The system environment 100, shown in FIG. 7, includes a social networking system 704, a client device 708, a merchant system 712, a financial transaction service provider 114, and a network 740. Alternatively, the system environment 100 can include different and/or additional components than those shown in FIG. 7.

The social networking system 704, further described below in conjunction with FIG. 8, includes one or more computing devices storing user profiles associated with users and/or other objects as well as connections between users and other users and/or objects. In use, users join the social networking system 704 and then add connections to other users or objects of the social networking system to which they desire to be connected. As further described below in conjunction with FIG. 8, users of the social networking system 704 can be individuals or entities such as businesses, organizations, universities, manufacturers. The social networking system 704 allows its users to interact with each other as well as with other objects maintained by the social networking system 704. The social networking system 704 can therefore allow users to interact with third-party websites, such as the merchant system 712 and the financial transaction service provider 716. In one implementation, third-party developers can enable users of the social networking system to express interest in web pages hosted on websites external to the social networking system (e.g., third-party websites). These web pages can be represented as page objects in the social networking system as a result of embedding a widget, a social plug-in, programmable logic or code snippet into the web pages, such as an iFrame. Any concept that can be embodied in a web page can become a node in the social graph on the social networking system in this manner. As a result, users can interact with many objects external to the social networking system. Each of the interactions with an object can be recorded by the social networking system as an edge. These interactions can be used, for example, to identify a gift-appropriate event of the recipient. Enabling third-party developers to define object types and action types is further described in a related application, “Structured Objects and Actions on a Social Networking System,” U.S. application Ser. No. 13/239,340 filed on Sep. 21, 2011, which is hereby incorporated by reference. In one embodiment, the interaction can be a comment associated with a content object hosted by a third party system, as further described in a related application, “Comment Plug-In for Third Party System,” U.S. application Ser. No. 12/969,368 filed on Dec. 15, 2010. As such, the electronic communication may be entered into a comment field of an embedded widget, a social plug-in, programmable logic or code snippet into a third party web page, such as an iFrame

Based on stored data about users, objects and connections between users and/or objects, the social networking system 704 generates and maintains a “social graph” comprising a plurality of nodes interconnected by a plurality of edges. Each node in the social graph represents an object or user that can act on another node and/or that can be acted on by another node. An edge between two nodes in the social graph represents a particular kind of connection between the two nodes, which can result from an action that was performed by one of the nodes on the other node. For example, when a user identifies an additional user as a friend or confirms a friend request from another user, the method can generate an edge in the social graph generated connecting a node representing the first user and an additional node representing the additional user. The generated edge has a connection type indicating that the users are friends. As various nodes interact with each other, the social networking system 704 modifies edges connecting the various nodes to reflect the interactions.

A client device 708 is a computing device capable of receiving user input as well as transmitting and/or receiving data via the network 740. In one implementation, the client device 708 is a conventional computer system, such as a desktop or laptop computer. In another implementation, the client device 708 can be a device having computer functionality, such as a personal digital assistant (PDA), mobile telephone, smart-phone or similar device. The client device 708 is configured to communicate with the social networking system 704, the merchant system 712 and/or the financial transaction service provider 716 via the network 740. In one implementation, the client device 708 executes an application allowing a user of the client device 708 to interact with the social networking system 704. For example, the client device 708 executes a browser application to enable interaction between the client device 708 and the social networking system 704 via the network 740. In another implementation, a client device 708 interacts with the social networking system 704 through an application programming interface (API) that runs on the native operating system of the client device 708, such as iOS® or ANDROID™.

The client devices 708 are configured to communicate via the network 740, which can include any combination of local area and/or wide area networks, using both wired and wireless communication systems. In one implementation, the network 740 uses standard communications technologies and/or protocols. Thus, the network 740 can include links using technologies such as Ethernet, 802.11, worldwide interoperability for microwave access (WiMAX), 3G, 4G, CDMA, digital subscriber line (DSL), etc. Similarly, the networking protocols used on the network 740 can include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 740 can be represented using technologies and/or formats including hypertext markup language (HTML) or extensible markup language (XML). In addition, all or some of the links can be encrypted using conventional encryption technologies such as secure sockets layer (SSL), transport layer security (TLS), and Internet Protocol security (IPsec).

The merchant system 712 includes one or more servers providing content associated with a merchant. For example, the merchant system 712 provides web pages describing products and/or services sold by one or more vendors. The merchant system 712 can also perform other functions to allow the merchant to provide products or services in exchange for compensation. Examples of functions provided by the merchant system 712 include maintaining accounts for purchasers, tracking inventory levels, modifying pricing of products or services, obtaining compensation for products or services from the financial transaction service provider 716 and/or other suitable actions. The merchant system 712 communicates with the social networking system 704, and/or the financial transaction service provider 716 via the network 740.

The financial transaction service provider 716 processes virtual currency transactions between a merchant and a customer, such as credit, debit, private-label, gift, payroll, a prepaid card, and/or other virtual currency, credit, or debit transaction. The financial transaction service provider 716 therefore directs a fund from a financial account of a consumer to a financial account of a merchant in response to a consumer purchase and can further direct a fund from a merchant to a consumer, such as in response to a return or exchange. The financial transaction service provider 716 can further provide fraud protection and authentication solutions, electronic check acceptance services, and/or Internet commerce and mobile payment solutions.

FIG. 8 is a block diagram of a system architecture of the social networking system 704. The social networking system 704 shown in FIG. 8 includes a user profile store 804, a content store 808, an edge store 820, an action logger 214, an action log 832, a suggestion engine 824, a financial account store 828 and a web server 232. Alternatively, the social networking system 704 can include additional, fewer, or different modules for various applications. Conventional components such as network interfaces, security mechanisms, load balancers, failover servers, management and network operations consoles, and the like are not shown so as to not obscure the details of the system architecture.

Each user of the social networking system 704 is associated with a user profile, which is stored in the user profile store 804. A user profile includes declarative information about the user that was explicitly shared by the user, and can also include profile information inferred by the social networking system 704. In one implementation, a user profile includes multiple data fields, each data field describing one or more attributes of the corresponding user of the social networking system 704. The user profile information stored in user profile store 804 describes the users of the social networking system 704, including biographic, demographic, and other types of descriptive information, such as work experience, educational history, gender, hobbies or preferences, location and the like. A user profile can also store other information provided by the user, for example, images or videos. Images of users can be tagged with identification information of users of the social networking system 704 displayed in an image. A user profile in the user profile store 804 can also maintain references to actions by the corresponding user performed on content items in the content store 808 and stored in the edge store 820.

A user profile can be associated with one or more financial accounts, which enables tracking of prepaid gifts and redemption of those gifts when using an associated financial account. A user can specify one or more privacy settings, which can be stored in the user profile. The privacy settings can specify the content and quantity of (personal) user data that can be tracked, shared, and/or accessed by the social networking system 704. In one implementation, information from the financial account is stored in the user profile store 804. Alternatively, information can be stored in the financial account store 828.

The content store 808 stores content items associated with a user profile, such as images, videos or audio files. Content items from the content store 808 can be displayed when a user profile is viewed or when other content associated with the user profile is viewed. For example, displayed content items can show images or video associated with a user profile or show text describing a user's status. Additionally, other content items can facilitate user engagement by encouraging a user to expand his connections to other users, to invite new users to the system or to increase interaction with the social network system by displaying content related to users, objects, activities, or functionalities of the social networking system 704. Examples of social networking content items include suggested connections or suggestions to perform other actions, media provided to, or maintained by, the social networking system 704 (e.g., pictures or videos), status messages or links posted by users to the social networking system, events, groups, pages (e.g., representing an organization or commercial entity), and any other content provided by, or accessible via, the social networking system.

The content store 808 also includes one or more pages associated with entities having user profiles in the user profile store 804. An entity is a non-individual user of the social networking system 704, such as a business, a vendor, an organization or a university. A page includes content associated with an entity and instructions for presenting the content to a social networking system user. For example, a page identifies content associated with the entity's user profile as well as information describing how to present the content to users viewing the brand page. Merchants associated with merchant systems 712, further described above in conjunction with FIG. 7, can be associated with pages in the content store 808, allowing social networking system users to more easily interact with the merchant via the social networking system 704. A merchant identifier is associated with a vendor's page, allowing the social networking system 704 to identify the merchant and/or to retrieve additional information about the merchant from the user profile store 804, the action log 832 or from any other suitable source using the vendor identifier.

The action logger 812 receives communications about user actions on and/or off the social networking system 704, populating the action log 832 with information about user actions. Such actions can include, for example, adding a connection to another user, sending a message to another user, uploading an image, reading a message from another user, viewing content associated with another user, attending an event posted by another user, among others. Moreover, the actions can relate to a merchant. In one example, a user can “like” an object associated with the merchant, for example, by explicitly making that indication on the merchant's page in the social network. In another example, a user can comment on a merchant's page within the social network, share a story from the merchant's page, tag a photo associated with the merchant or a product or service provided by the merchant, become a fan of the merchant, check-in to a brick-and-mortar store of the merchant, or subscribe or follow the merchant. As described in U.S. patent application Ser. No. 13/239,340, which is incorporated herein by reference, the edge store 820 can correlate any one or more such user actions with an interest in the merchant or a product of service from the merchant, which can be useful in selection an appropriate gift for the user who is a recipient.

The action log 832 can be used by the social networking system 704 to track user actions on the social networking system 704, as well as external website that communicate information to the social networking system 704. Users can interact with various objects on the social networking system 704, including commenting on posts, sharing links, and checking-in to physical locations via a mobile device, accessing content items in a sequence or other interactions. Information describing these actions can be stored in the action log 832, and the extent and content of such interactions can be correlated with an affinity for the objects. Additional examples of interactions with objects on the social networking system 704 included in the action log 832 include commenting on a photo album, communications between users, becoming a fan of a musician, adding an event to a calendar, joining a group, becoming a fan of a brand page, creating an event, authorizing an application, using an application and engaging in a transaction. Additionally, the action log 832 records a user's interactions with advertisements on the social networking system 704 as well as other applications operating on the social networking system 704. Data from the action log 832 is used to infer interests or preferences of the user, augmenting the interests included in the user profile and allowing a more complete understanding of user preferences.

The action log 832 can also store user actions on external websites and/or determined from a financial account associated with the user. For example, an e-commerce website that primarily sells sporting equipment at bargain prices can recognize a user of a social networking system 704 through social plug-ins that enable the e-commerce website to identify the user of the social networking system 704. Because users of the social networking system 704 are uniquely identifiable, e-commerce websites, such as this sporting equipment retailer, can use the information about these users as they visit their websites. The action log 832 records data about these users, including webpage viewing histories, advertisements that were engaged, purchases made, and other patterns from shopping and buying, such as in accordance with privacy settings of the user. Actions identified by the action logger 812 from the transaction history of a financial account associated with the user allow the action log 832 to record further information about additional types of user actions.

In one embodiment, an edge store 820 stores information describing connections between users and other objects on the social networking system 704 as edge objects. Some edges can be defined by users, allowing users to specify their relationships with other users. For example, users can generate edges with other users that parallel the users' real-life relationships, such as friends, co-workers, partners, etc. Other edges are generated when users interact with objects in the social networking system 704, such as expressing interest in a page on the social networking system, sharing a link with other users of the social networking system, and commenting on posts made by other users of the social networking system. The edge store 820 stores edge objects that include information about the edge, such as affinity scores for objects, interests, and other users. For example, an affinity score between a user and a merchant can be stored. Affinity scores can be computed by the social networking system 704 over time to approximate a user's affinity for an object, interest, and other users in the social networking system 704 based on the actions performed by the user. Multiple interactions between a user and a specific object can be stored in one edge object in the edge store 820, in one embodiment. Connections between users can be stored in the user profile store 804, or the user profile store 804 can access the edge store 820 to determine connections between users.

In one implementation, the financial account store 828 includes financial account identifiers associated with user profiles and an association or mapping between a financial account and its corresponding user profile. A user can include additional information about the financial account in the financial account store, such as a description of the financial account and can also include authentication information for accessing the account such as names, passwords or other security credentials. In implementation in which information about user financial accounts are stored in the financial account store 828, the social networking system 704 can apply additional security measures (encryption, etc.) to the financial account store 828 to reduce the risk of unauthorized access to financial account information. Alternatively, financial account information can be included in the user profile store 804 as data in a user's user profile. One or more privacy settings can be applied to the financial account information to limit its accessibility to objects in the social networking system 704.

The suggestion engine 824 accesses data in the user profile store 804, user profile store 804, in the action log 832, and/or the content store 808 either individually or in combination and identifies one or more candidate products associated with vendors in which a user is likely to have an interest. Generally, the suggestion engine can analyze the action log 832, identify user actions related to one or more merchants, products, or services, calculate the user's affinity for one or more merchants, products, or services, and select a suitable gift for the user based on the user's affinity. The suggestion engine 824 can also collect offers for products from local merchants, wherein the products can be collected or fulfilled through a physical retail location and/or through e-commerce. The suggestion engine 824 can further calculate an affinity between a user who is a (potential) recipient and a second user who is a (potential) sender, such as based on interactions between the users including messages, posts, and/or other communications between the users within the social networking system, and select the second user as the sender based on the affinity between the users. The suggestion engine 824 can subsequently recommend the selected gift to the sender and facilitate sender purchase of the product for the recipient.

Actions between the user and pages maintained by the social networking system stored in the action log 832 can be used by the suggestion engine 824 to select candidate products. The suggestion engine 824 can analyze actions involving the user and various pages in the content store 808 as well as connections between the user and various pages in the edge store 820 to select candidate products. For example, the suggestion engine 824 selects candidate products based on the frequency of actions between the user and a page, the number of interactions between the user and the page, the type of connection between the user and a page, staleness of the interactions, a type of action between the user and a page or any other suitable criteria.

The financial account store 828 can store a financial account identifier of one or more user IDs or profiles within the social networking system. The financial account store 828 can cooperate with the financial transaction service provider to track gifts, gift values, gift description, gift contents, etc. for a particular merchant and control application of a gift to a recipient purchase based on an identified match between a gift and a recipient purchase at the particular merchant. For example, the financial account store 828 can analyze merchant transactions, match a user social network ID to the purchase, and select an available gift affiliated with the user and redeemable at the merchant. The financial account store 828 can then communicate this information to the financial transaction service provider to initiation deduction of the gift amount from the recipient's bill without exposing user (e.g., sender or recipient) identification information to the financial transaction service.

The web server 232 links the social networking system 704 via the network 740 to the client device 708, to the financial transaction service provider 716 and/or to the merchant system 712. The web server 232 serves web pages, as well as other web-related content, such as Java, Flash, XML and so forth. The web server 232 can provide the functionality of receiving and routing communications between the social networking system 704 and the client device 708, for example, instant messages, queued messages (e.g., email), text and SMS (short message service) messages, or messages sent using any other suitable messaging technique. A user can send a request to the web server 232 to upload information, for example, images or videos that are stored in the content store 808. Additionally, the web server 232 can provide application programming interface (API) functionality to send data directly to native client device operating systems, such as iOS®, ANDROID™, webOS® or RIM. The web server 232 also provides API functionality for exchanging data, such as financial account information, between the social networking system 704 and the financial transaction service provider 716.

Block S110 of the method S100 recites receiving a set of communications from a set of users, the communications directed to a recipient through a social networking system. Block S110 functions to collect communications previously sent to the recipient by multiple other users, wherein these communications are subsequently analyzed in Block S120A to identify a gift-appropriate event of the recipient. The set of users can include one or more users, and the set of communications can include one or more communications. Block S110 can collect private ‘store and forward’ messages sent from a user to the recipient (e.g., Facebook Messages), private real-time messages sent from a user to the recipient (e.g., Facebook Instant Messenger), or public messages sent from a user to the recipient (e.g., a Facebook wall or timeline post). However, Block S110 can additionally or alternatively collect messages communicated between a user and the recipient from sources that are external to the social networking system, such as emails, SMS text messages, tweets, phone calls, voicemail messages, electronic greeting cards, etc. By collecting multiple messages, Block S110 can limit false positives of gift-appropriate events by maintaining a pool of communications accessible to Block S120A to substantiate identification of a gift-appropriate event.

Block S120A of the method S100 recites identifying a gift-appropriate event of the recipient based on the communications. Generally, Block S120A functions to extract identifiers of a gift-appropriate event from communications directed to the recipient. As described above, the communications can include any one or more of a private message delivered from a user to the recipient through a social networking system, a private message delivered from a user to the recipient through an external messaging platform, a public message posted to a wall, timeline, or other message board related to a social networking profile of the recipient, or any other suitable form of text-, image-, video-, or audio-based messaging. Block S120A can identify an occasion of a gift-appropriate, as well as particular details of the gift-appropriate event, such as a type or category of the event. For example, Block S120A can determine the event to be a birthday, a graduation, a marriage, new employment, a holiday, a win in a competitive event, a raise, a recent purchase (e.g., a dog), birth of a child, return from an extended hospital stay, or any other suitable event.

In one implementation, Block S120A counts the frequency of communications delivered to the recipient on a particular date or range of dates and compares this frequency with the frequency of communications delivered on other dates. In this implementation, Block S120A can associate a sharp increase in communication frequency on a particular date, relative communication frequency on previous dates, with a gift-appropriate event. For example, if a potential recipient typically receives, on average, between three and six communications each day, but on a particular day received thirty-two communications, Block S120A can conclude that the a gift-appropriate event occurred or is occurring on the particular day. Alternatively, Block S120A can handle the sharp increase in communication frequency on the particular date as a trigger for analysis of communication content to confirm the gift-appropriate event of the recipient.

In another implementation, Block S120A implements natural language processing to extract words, phrases, or images indicative of the gift-appropriate event from the communications, such as subject to privacy settings of the sender and/or recipient. For example, Block S120A can associate multiple communications directed from users to recipients and including the words “graduation,” “birthday,” or “congratulations” with a graduation, a birthday, and a new job, respectively, such as by comparing phrases or keywords in the communications with template words or phrases associated with particular gift-appropriate events. In another example, Block S120A can implement object recognition to correlate communication content with a gift-appropriate event. For example, Block S120A can correlate a communication sent to the recipient and including an image of balloons with a birthday. Block S120A can similarly implement information extraction, text mining, text analytics, textual analysis, content analysis, semantic analysis, and/or any other analysis or machine learning technique to extract identifying and/or gift-related information from communications between users and the recipient. In one implementation, topics indicative of a gift-appropriate event can be inferred, for example, as described in U.S. patent application Ser. No. 13/167,702, field on 24 Jun. 2011, titled, “Suggesting Tags in Status Messages Based on Social Context.”

Block S120A can additionally or alternatively analyze non-textual communications between users and the recipient, such as voicemail messages or phone calls, to identify the gift-appropriate event. Block S120A can also amass gift event indicators across multiple communication platforms to identify the gift-appropriate event.

Block S120A can implement gift event indicators as triggers for recipient selection and gifting event identification, and the method can further implement the gift event indicators as triggers for subsequent Blocks of the method. For example, Block S120A can identify a suitable recipient and associated gifting event once a suitable number (e.g., threshold) of triggers are extracted from communications directed to a user within the social networking system. Block S120A can also associate a gift event trigger with a predefined event category within set of predefined event categories, such as the list {birthday, graduation, new job, baby, wedding, win by favored sports team, completion of exam or test, promotion, death of family member or friend, loss of job, or new dog}. Given a suitable number of gift event triggers of the same type, Block S120A can thus identify the gift-appropriate event.

Block S120A can therefore apply a threshold number of communications delivered to the recipient and/or including a gift-appropriate event indicator to confirm the gift-appropriate event. For example, Block S120A can adhere to a set number of communications (e.g., five) sent to the recipient and including gift-indicative language to trigger identification of the gift-appropriate event. Block S120A can also implement a dynamic gift-appropriate event trigger threshold, such as based on a demographic, social network use or communication history, social network connections, or any other parameter related to the sender and/or recipient. For example, the threshold can be low (e.g., five) for a recipient between the ages of fifty and sixty and high (e.g., twenty) for a recipient between the ages of fourteen and eighteen. The threshold can also be higher for female recipients than for male recipients (e.g., if females tend to receive more communications, on average, than males), and the threshold can be higher for a recipient with 1000 connections than for recipients with only fifty connections.

When identifying a trigger of a gift-appropriate event, Block S120A can also account for the degree of connection between the sender and other users who have sent communications to the recipient. For example, Block S120A can associate greater weight to communications sent to the recipient by other users who are closely connected to the sender than to communications sent to the recipient by other users who are only distantly connected to the sender through the social networking system. Block S120A can also identify a degree of a relationship or connection between a potential sender and a potential recipient, such as by ranking a list of potential senders based on a determined strength of a relationship with the recipient. For example, Block S120A can rank immediate family members first, following by close friends, extended family, relatively close friends, coworkers, and, finally, acquaintances or distant friends. To determine the strength of a relationship between the recipient and a potential sender, Block S120A can assess a number of pictures uploaded to the social networking system and tagged as including both the recipient and potential sender, a number of communications communicated between the recipient and potential sender within a period of time over the social networking system, common likes and/or common check-ins between the recipient and potential sender, such as at similar times, or any other factor indicative of a relationship or connection between the recipient and potential sender.

Block S120A can also calculate, specify, and/or customize a particular threshold number of communications to trigger identification of the gift-appropriate event for the recipient, such as by accounting for a demographic, social network use or communication history, social network connection, or any other parameter related to the sender and/or to the recipient. Block S120A can therefore tailor the threshold number of communications to trigger gifting event identification for a particular sender, for a particular recipient, or for a particular sender connected to a particular recipient.

As in the first variation described above, Block S120B recites identifying a gift-appropriate event of a recipient based on an incomplete textual electronic note drafted by the sender, the electronic note entered into a social networking system and designating the recipient. Generally, Block S120B can apply analysis techniques of Block S120A, described above, to extract a complete or incomplete phrase from the sender's note while the sender is typing and, from this phrase, determine the occurrence and type of a recent gift-appropriate event of the recipient. For example, Block S120B can implement information extraction and template matching to identify a birthday of the recipient based on the incomplete phrase “happy bi . . . ” entered into a note drafted by the sender and designating the recipient. Alternatively, Block S120B can implement natural language processing techniques to identify the gift-appropriate event from a complete phrase entered into the note by the sender. For example, from the note that reads “Tom, we are so glad you're finally home from the hospital. You gave us quite a scare, but we're delighted to hear you'll be 100% again soon,” Block S120B can determine that the recipient has returned from a substantially long hospital stay. By further accounting for a demographic of the sender or recipient, the relationship between the sender and the recipient, the location of the recipient, an interest of the sender or recipient, etc., the method S100 can further confirm the occasion of the gift-appropriate event.

As in the second variation described above, Block S120C recites identifying a gift-appropriate event of a recipient based on personal information entered, by the recipient, into a social networking system. In one implementation, Block S120C extracts a gifting event from changes made by the recipient to his social network profile. For example, Block S120C can identify the gift-appropriate event as a marriage based on a recipient-entered change in marital status from “engaged” to “married.” In another implementation, Block S120C correlates a gifting event with new information entered by the recipient into his social network profile. For example, Block S120C can apply any of the foregoing natural language processing techniques to identify a significant life milestone for the recipient based on a recipient-entered public update that reads “guess who just passed the bar exam!” Block S120C can then correlate this life milestone with a gift-appropriate event. In yet another implementation, Block S120C correlates a gift-appropriate event based on a communication entered by the recipient and communicated through the social networking system, such as by implementing natural language processing. For example, Block S120C can determine an upcoming graduation of the recipient based on a communication sent by the recipient (e.g., to a family member) that reads, “Graduation is this Sunday, and Commencement begins at loam. Try to get to the auditorium by 9:45 so you'll be guaranteed a seat.” However, Block S120C can apply any other suitable technique or method to extract a gifting event indicator from a public or private message, note, update, profile change, or account adjustment entered by the recipient.

Blocks S120A, S120B, and/or S120C can also implement a confidence interval threshold, wherein the foregoing Blocks calculate a likelihood (or confidence interval) that user communications, sender note content, and/or recipient-entered data are indicative of a gift-appropriate event. Once this likelihood reaches and/or surpasses the confidence interval threshold, Blocks S120A, S120B, and/or S120C can recognize that the gift-appropriate event likely occurred and thus move to Block S130, S140, etc.

Blocks S120A, S120B, and/or S120C can further include analyzing a recipient's posts with the social networking system, analyzing other users' posts, analyzing a recipient's behavior within and outside of the social networking system, or collecting and/or analyzing any other user and/or recipient related information inside or outside of the social networking system. However, Block S110 can function in any other suitable way to identify a gift-appropriate event of the recipient.

Block S130 of the method S100 recites determining an intent of a sender to respond to the gift-appropriate event of the recipient based on an incomplete electronic note designating the recipient and drafted by the sender from within the social networking system. Generally, Block S130 functions to correlate an action of the sender with a period of time during which the sender is engaging in altruistic activity on behalf of the recipient and in response to the gift-appropriate event. Block S130 can function in real-time to estimate the sender's intent, such as while the sender is typing a private ‘store and forward’ message, a private real-time message, or a public (e.g., wall or timeline) message. By analyzing an incomplete electronic note drafted by the sender in a message field designating the recipient, Block S130 can enable the method S100 to broadcast a targeted, personalized advertisement that is particularly relevant to the sender at a time in which the sender is substantially likely to respond to the recommendation. By estimating the intent of the sender prior to completion of the note, Block S130 can further enable the method S100 to target a recommendation that is substantially guaranteed sender visibility for as long as the sender continues to draft the note.

The sender's action, analyzed in Block S130, can include drafting a text-based note, generating an image, assembling a video, inserting an icon, image, or video into a message field, or any other discernible response to the gift-appropriate event. In one implementation, Block S130 implements one or more foregoing textual analysis techniques to identify a reference to the gift-appropriate event within a note or other communication drafted by the sender and designating the recipient. Block S130 can also implement predictive text techniques to determine the context and/or meaning of an incomplete word or phrase within the note. In an example of the first variation, Block S120C identifies the gift-appropriate event as the birth of a child based on information entered by the recipient, and Block S130 correlates the incomplete phrase “Congra . . . ,” entered by the sender into a message field designating the recipient, with an intent of the sender to positively respond to the birth. Generally and similar to Block S120A and S120B described above, Block S130 can implement template matching, contextual analysis, predictive text, semantic analysis, content analysis, and/or any other suitable technique to correlate a word or phrase, entered by the sender into the incomplete note, with a sender response to the gift-appropriate event.

In an alternative implementation, Block S130 correlates sender access to a communication path designating the recipient as indicative of sender intent to respond to the gift-appropriate event. In an example, once Block S110 collects multiple communications from other users and directed to the recipient, and once Block S120C identifies the gift-appropriate event based on the communications, Block S130 correlates a particular sender action with sender intent to respond to the event, the particular action including opening a message field on a social networking page of the recipient. However, Block S130 can implement any other suitable technique to estimate or determine sender intent to respond to the gift-appropriate event.

Block S130 can further extract personalized elements from the note drafted by the sender, such an events details, sender or recipient interests, relationships, sender or recipient location, future plans of the sender or recipient, etc, such as based on sender or recipient privacy settings. As in the example above in which Block S120C identifies the gift-appropriate event as the birth of a child based on information entered by the recipient, Block S130 can initially correlate the incomplete phrase “Congra . . . ,” entered by the sender, with an intent of the sender to respond to the birth, and Block S130 can subsequently extract the child's name from the more complete note that reads “Congratulations! Little Timmy is the cutest ba . . . ” In this example, Block S140 can subsequently apply the extracted child's name when selecting the gift, such as by selecting a gift that is a blue (rather than pink) bib embroidered “Timmy.” In another example, Block S130 can correlate a sender-entered phrase “happy birthday! can't wait for the party on frid . . . ” with a stronger relationship between the sender and the recipient than for a second user who simply enters “happy birthday!” In this example, Block S140 can determine that the event is a suitable gifting opportunity for the sender based on his close relationship with the recipient and subsequently select a gift, and Block S140 can also determine that the event is not a suitable gifting opportunity for the second user based on his less personal relationship with the recipient. In yet another example, Block S130 can determine that the recipient likes comic books based on the sender's note that reads “marvel comics? wow. can't believe you landed your dream job. congratul . . . ” In this example, Block S140 can subsequently select a gift that is a rare Marvel comic book, a Marvel action figure, or tickets to a showing of an upcoming Marvel movie. However, Block S130 can function in any other way to extract any other event-, sender-, and/or recipient-related details from the note drafted by the sender.

As shown in FIGS. 9 and 12, Block S140 of the method S100 recites selecting a gift for the recipient in response to the determined intent of the sender. Block S140 can select a gift that is a tangible or virtual product, a physical or virtual service, a real or virtual experience, or any other suitable type of gift. Block S140 can also select the gift that is an end-use product (e.g., a digital music album, hardback book) or a gift card.

After the sender's intent to respond to the gift-appropriate event is identified in Block S130, Block S140 selects a gift that is a suitable for the sender in light of at least one of the type of event, the relationship between the sender and recipient, a gift previously sent to the recipient, or an interest, like, demographic, purchase history, return history, exchange history, or location of the sender or recipient. Based on any one or more of these factors, Block S140 can select a product or service that both meets gifting needs of the sender and is suitable as a gift from the sender to the recipient. For example, Block S140 can access personal and/or contact information of the sender and/or recipient to determine that the sender is a grandparent of the recipient and, based on this, select a higher-priced item than for a second user who is a friend and peer of the recipient. In another example, Block S140 can access location and personal data of the recipient to determine that the recipient is a teenage girl living in Portland, Oreg. and, from this data select a gift that includes two movie tickets for a romantic comedy playing at a local theatre rather than an entry ticket and beer ticket at a NASCAR event at Atlanta Motor Speedway in Hampton, Ga. In yet another example, Block S140 can access personal information entered by the recipient to determine that the recipient is a vegetarian, and, based on this information, avoid gifts for the recipient that are gift cards for local steakhouses. In yet another example, Block S140 can retrieve purchase records of the recipient to determine that the recipient frequently shops at a particular store and, from these records, select a gift that is a credit at the particular store (e.g., rather than a credit at a store not frequented by the recipient).

Block S130 can also select the product or merchant based on a determined recipient affinity for a particular product or merchant, such as described in U.S. patent application Ser. No. 12/978,265, which is incorporated in its entirety by this reference. For example, Block S140 can determine a recipient need, interest, and/or affinity based on a combination (e.g., weighted combination) of recipient interaction data within the social networking system and/or recipient purchase history. Furthermore, in identifying a particular product or merchant from a list of multiple products, services, or merchants, Block S140 can rank recommendations for products, services, or merchants based on a recipient affinity prediction model or a recipient social contact affinity prediction model, such as described in U.S. patent application Ser. No. 12/978,265. This model can also account for other gifts sent to the recipient by other users, such as duplicates and complementary products or services, when identifying recipient need to interest.

For example, the recipient can “like” a product or merchant by selecting a “Like” button on a website or from within the social networking system, such as through a web browser or within a native application, wherein Block S140 thus identifies the product or merchant as of interest to the recipient. In this example, by associating “likes” with a merchant, Block S140 can promote the value of “likes” for the merchant by converting a “like” to merchant revenue through gifting. In particular, Block S140 can associate a recipient “like” of the merchant with recipient interest in the merchant and subsequently select a gift offered by the merchant.

Block S140 can additionally or alternatively identify recipient interest based on a social graph, such as described in U.S. patent application Ser. No. 13/239,340, which is incorporated in its entirety by this reference. In this implementation, Block S140 can analyze a social graph incorporating data collected outside of the social networking system, such as Internet browsing history, downloaded content (e.g., music, e-books), viewed online content (e.g., videos), search history, etc. to extract recipient preferences, interests, needs, etc. However, Block S140 can identify a need or interest of the recipient and correlate the need or interest with a particular product, service, or merchant in any other way.

Block S140 can also interface with external hardware components and/or physical locations when selecting the gift. For example, Block S140 can access a current location of the recipient through a GPS module incorporated into a mobile computing device (e.g., digital multimedia device, smartphone, tablet) carried by the recipient and subsequently select the gift based on the recipient's proximity to a local merchant, such as an ice cream parlor within three blocks of the recipient's present location. In one implementation, Block S140 tracks a current location of the recipient such that Block S150 can prompt the sender to send the gift to the recipient when the recipient is at or suitably near an appropriate merchant or retailer. In one example, Block S120C monitors recipient check-ins and Block S150 prompts the sender to purchase the gift for the recipient when the recipient checks in to a retailer that offers the gift for sale. Block S140 can also track the location of the recipient through a GPS module incorporated in a smartphone carried by the recipient and similarly prompt the sender to purchase the gift for the recipient. Alternatively, Block S140 can track or access data pertaining to the recipient's location and/or monitor recipient check-ins identify a retailer within a specified distance from the recipient, and select the gift that is offered by the retailers. In this implementation, Block S140 can select the gift and Block S150 can prompt the sender to purchase the gift for the recipient substantially in real time such that the sender has the opportunity to send the gift to the recipient when the gift may be particularly relevant or useful for the recipient. Block S150 can also notify the recipient of the gift substantially in real time (e.g., substantially immediately following sender gift confirmation). For example, Block S140 can access a recipient check-in at Philz Coffee, access “like” data of the recipient, determine that the recipient likes Philz Coffee, and select a gift that is a $5 gift card at Philz Coffee, Block S120 can select a daughter of the recipient as the sender, and Block S150 can prompt the daughter to purchase the $5 gift card for her mother. Once the daughter orders the gift for her mother, the method S100 can substantially immediately notify the mother of the gift such that the mother can apply the gift to a purchase at Philz in the same visit.

Block S140 can also determine common interests between the sender and recipient based on current and/or past communications between the sender and the recipient. Block S140 can subsequently apply this common interest to select a gift that can be used by the sender and recipient together. In one example, Block S140 can determine that the sender and recipient have frequented water parks together in the past, such as based on a caption of an image of the sender and recipient at a water park, a sender and/or recipient check-in at a water park, or a message, referencing a water park, communicated between the sender and the recipient. In this example, Block S140 can subsequently select a gift that includes two entry tickets to a local water park such that the recipient may involve the sender in redemption of the gift.

Similarly, Block S140 can access personal data entered into the social networking system by the recipient to identify a partner, girlfriend, boyfriend, spouse, or other close companion of the recipient. Block S140 can subsequently isolate common interests and/or actions of the recipient and his companion to select a gift suitable for both. For example, Block S140 can determine that the recipient and her boyfriend enjoy dinner at a particular restaurant and a movie on the first Friday of every month based on check-ins entered by her boyfriend and her purchase history. Based on this substantially regular action, Block S140 can select the gift that includes a bottle of wine at the particular restaurant.

Block S140 can also determine recipient interests by analyzing communications between the recipient, the sender, and/or other users. For example, Block S140 can identify recipient interest in fishing based on a recent communication, sent to the recipient by another user, that reads, “Happy birthday, Tom. Let's catch up after you get back from your fishing trip.” In this example, Block S140 can subsequently select a gift that include fishing tackle or that is otherwise related to fishing. Block S140 can therefore select the gift that is a product or service that meets identified or determined needs, interests, or expectations of the recipient.

Block S140 can select the gift further based on a purchase history of the sender. For example, Block S140 can determine, based on the sender's gifting history, that the sender is comfortable with a maximum gift price of approximately $30 for family members, approximately $20 for his closest friends, and approximately $10 for other relatively close friends. Similarly, Block S140 can select the gift further based on a sender preferences entered into a gifting platform within the social networking system and/or into a gifting profile of the sender. For example, Block S140 can access gift price preferences entered into sender's gifting profile. Block S140 can similarly determine or access data pertaining to minimum spending preferences of the sender. Block S140 can thus avoid selecting a gift that is too expensive or too cheap for the sender based on determined or entered sender data. For example, for a recipient who enjoys drinking Scotch, Block S140 can select the gift that is a cheaper blended Scotch rather than a single-malt Islay Scotch in order to meet spending expectations and/or requirements of the sender.

Alternatively, in the foregoing example, Block S140 can select the more expensive single-malt Islay Scotch, which the recipient may be more likely to enjoy, and Block S150 can subsequently recommend the selected gift to the sender as a commitment to pay for a portion of the gift once a gifting tipping point is reached by other users who also commit to paying for a portion of the gift. Therefore, Block S140 can source funding for a particular gift from multiple senders. Generally, to support gifting of a gift that is more expensive than what any single sender is willing to purchase for the recipient, Block S140 can select the gift according to an anticipated payment scheme involving multiple senders, and the method S100 can initiate payment by the senders for the gift only once an adequate monetary value is committed by the senders to pay for the gift. The method S100 can thus enable gifting of an expensive gift to the recipient while still fulfilling gifting needs and/or expectations of the sender.

Block S140 can also function to determine whether the event is appropriate for a gift from the sender. Generally, Block S140 can extract sender-recipient relationship data from personal or contact data of the social networking profiles of the sender and the recipient, such as based on sender and recipient privacy settings. In one example, for an event that is a birthday of the recipient, Block S140 can determine that the event is an appropriate gifting event for a potential sender who is a family member of the recipient but not for a user who is a coworker of the recipient. In another example, for an event that is a wedding of the recipient, Block S140 can determine that the event is an appropriate gifting event for a potential sender who is a close friend of the recipient but not for a user who is merely a professional acquaintance of the recipient. Block S140 can therefore function to filter out inappropriate gifting events for senders and thus limit gift advertisements (in Block S150) to events particularly relevant to the sender.

Similarly, Block S140 can determine whether the event is an appropriate gifting opportunity for the sender based on a correlation between the sender and other users who have sent gifts to the recipient in response to the event. Generally, in determining the appropriateness of the event, Block S140 can attach a greater weight to a gift sent to the recipient by one user, who is closely connected to the sender, than to a gift sent to the recipient by a user who is only remotely connected to the sender. For example, if only distant connections to the sender have sent gifts and/or communications to the recipient, Block S140 can determine that the event is not a substantially relevant gifting opportunity for the sender. However, if close connections to the sender have sent gifts and/or communications to the recipient, Block S140 can determine that the event might be a substantially relevant gifting opportunity for the sender. Therefore, Block S140 can account for the degree of a relationship between the sender and other users when determining whether the event is a gift-appropriate event for the sender.

Block S140 can select the gift from any suitable pool of available gift items. In one example implementation, Block S140 selects the gift from a limited pool of gift items offered by a merchant under specific contract with the social networking system. In another example implementation, Block S140 selects the gift item by interfacing with an online merchant aggregator (e.g., Amazon.com). In yet another implementation, Block S140 can also select the gift item from a list of items “liked” by the recipient. Block S140 can also select the gift item from a list of items “pinned,” tweeted,” or otherwise mentioned in a communication by the sender, the recipient, and/or a contact of the sender or recipient within the social networking system. For example, Block S140 can select the gift that is a book “liked” by several close friends of the recipient, such as after determining that the recipient has not yet read the book based on textual analysis of a recent communication between the recipient and a friend that indicates the same. Block S140 can also select the gift item from a “wishlist” of the recipient, such as stored on an online merchant aggregator (e.g., Amazon.com), a window-shopping website (e.g., svpply.com), an online merchant (e.g., toryburch.com), or any other suitable online retail outlet. However, Block S140 can select the gift from any other suitable pool or list of available gift items.

Block S140 can also include monitoring gifts sent to the recipient by other users and thus exclude these previously-gifted items from a pool or list of items available to the sender as gifts for the recipient. Similarly, Block S140 can dismiss selection of the gift in favor of a second gift in response to submission of a gift order for the gift by a second user prior to submission of a gift order for the gift by the sender. Block S140 can therefore avoid selecting a gift that is a duplicate or substantially similar to another gift sent to the recipient by another user. Similarly, Block S140 can select a different gift item once a threshold period of time transpires following advertisement of the gift without a gift order submission from the sender.

Furthermore, Block S140 can select multiple gift items to be advertised to the sender in Block S150. For example, Block S140 can select three different items suitable as gifts for the recipient. The items can be of similar cost and function but be of different configurations or include different types or levels of personalization. The items can alternatively be of varying price in order to give the sender a substantially wide price window of available gifts. In this implementation, Block S140 can also rank the selected gifts, such as according to estimated interest of the recipient, estimated relevance to the sender, price, complementary correlation with a gift sent to the recipient by another user, or perceived recipient need. However, Block S140 can select and rank any other number of gifts according to any other price, function, configuration, specification, personalization, etc.

Block S150 of the method S100 recites displaying a recommendation to the sender prior to transmission of the note to the recipient, wherein the recommendation includes a suggestion to purchase the gift for the recipient. Once Block S140 selects the gift for the recipient, Block S150 functions to entice the sender to purchase the gift through timely application of a targeted advertisement of the gift. Generally, Block S150 advertises the gift to the sender while the sender is drafting (e.g., typing) the note and prior to transmission of the note to sender. Because the sender may navigate away from the webpage or sender interface once the note is sent to the recipient, Block S150 leverages the time that the sender accesses a webpage or sender interface to draw the attention of the sender to one or more specific products particularly germane to the sender's present action, that is, responding to the recipient's gift-appropriate event.

Block S150 can display the recommendation to the recipient in any one or more suitable ways. In one implementation, Block S150 highlights, underlines, emboldens, colors, or otherwise visually modifies a keyword or key phrase entered by the sender and displayed in a message field containing the note. For example, in a sender's note that reads “happy birthday, tom! can't wait for the party on . . . ,” Block S150 can embolden and underline the phrase “happy birthday.” In this example, when the sender hovers a mouse over or clicks on the phrase “happy birthday,” a popup advertisement can appears, thus notifying the sender of the gifting opportunity. In another implementation, Block S150 displays a static advertisement image adjacent the message field in which the users enters the note. For example, once the sender enters the phrase “happy birthday” into a message field designating the recipient, Block S150 can update webpage or sender interface to include an inline advertisement adjacent the message field in which the sender enters the note, thus notifying the sender of the gifting opportunity. In yet another implementation, Block S150 displays a popup notification including the recommendation for the gift. For example, once the sender opens a sender interface through a mobile computing device and enters the phrase “happy birthday” into a message field designating the recipient, Block S150 can trigger a popup notification including the recommendation, thus notifying the sender of the gifting opportunity. In an alternative variation, Block S150 can deliver the recommendation through an audible advertisement. For example, Block S150 can play a voice recording describing the gift, its cost, and its applicability to the recipient through a speaker incorporated into a digital multimedia device used by the sender or through a headset worn by the sender while drafting the note. However, Block S150 can visually and/or audibly advertise the gift to the sender in any other suitable way.

The recommendation can also be dynamic. In one implementation in which Block S140 selects multiple gifts, Block S150 cycles through the multiple gifts until the sender selects one for purchase or until the sender completes the note. In another implementation, Block S140 and Block S150 cooperate to update the recommendation as the sender enters additional information. In one example, when the sender designates the recipient and initially enters “happy birthday” into a message field, Block S140 selects a gift that is a bundle of balloons. When the sender augments the note to read “happy birthday, tom. let's grab dinner when you get back from your fishing trip,” Block S140 updates the gift selection to include a gift certificate to a steakhouse, and Block S150 updates the recommendation to reflect the new gift selection. And when the sender subsequently completes the note, which reads “happy birthday, torn. let's grab dinner when you get back from your fishing trip,” Block S140 updates the gift selection to include a gift certificate to a seafood restaurant, and Block S150 updates the recommendation to reflect this gift selection that reflects the completed note. Therefore, Block S150 can update the note based on new information added to the note by the sender.

Generally, Block S150 can also include modifying the recommendation for the gift prior to submission of a gift order, for the gift, by the sender. As described above, Block S140 can detect purchase of similar or identical items purchased for and/or delivered to the recipient by other users. Based on detection of a duplicate item, Block S140 can select an alternative gift, and Block S150 can update the recommendation to reflect to the alternative gift. Block S150 can additionally or alternatively include modifying parameters of the selected gift. For example, Block S150 can adjust the advertised price of the gift according to an amount of time since initial advertisement of the gift, prior to submission of a gift order from the sender. Similarly, Block S150 can adjust a shipping price for the gift, available gift configurations, gift personalization, etc. based on time. However, Block S150 can adjust the recommendation according to any other parameter, event, gift selection, etc. of Block S140, etc.

As shown in FIGS. 4 and 5, one variation of the method S100 further includes Block S160, which recites directing the sender to purchase the gift for the recipient. Generally, Block S160 enables a pathway through which the sender may compete a gift order for the gift. The pathway can be accessible to the sender through or adjacent the message field in which the sender composes the note such that minimal redirection or sender action is required to initiate the gift order. In one implementation, Block S160 includes displaying an input field adjacent the recommendation and confirming a gift order by the sender based on a sender input into the input field and subsequent transmission of the note to the recipient. For example, Block S160 can display a check box adjacent the recommendation, and the method S100 can process a gift order for the gift in response to a sender selection of the check box followed by sender submission of the note to the recipient. Alternatively, in response to sender selection of the check box and submission of the note to the recipient, the method S100 can automatically direct the sender to a retail venue or other online merchant through which the sender can enter payment information and recipient (virtual or street) address through which to deliver the gift. In another example, Block S160 can link an image of the gift in the recommendation to a retail venue or other online merchant, wherein the method S100 opens a popup window configured to receive sender payment information and a recipient delivery address following sender selection of the recommendation. However, Block S160 can implement any other suitable method or technique to enable the sender to purchase the gift.

Block S160 can access previously-entered sender payment information such that sender completion of the gift order, while drafting the note, is substantially seamless. For example, Block S160 can access the sender's social networking account that maintains the sender's virtual currency or virtual points (e.g., Facebook points) account or that stores sender checking, debit card, and/or credit card information. Block S160 can similarly access a billing address of the sender and can access a delivery address of the recipient. In one example, for the gift that is a virtual product, Block S160 can set the recipient's social network profile as the destination of the gift. In another example, for the gift that is a tangible product, Block S160 can mine a street address of the recipient from his social network profile, such as according to privacy settings set by the recipient. In yet another example, for the gift that is redeemable coupon for an experience, Block S160 can set an email address linked to the recipient's social network profile as the destination of the coupon. Alternatively, Block S160 can prompt the sender to enter any one or more of billing information, billing address, delivery information, shipping options, etc., such as in the event that certain sender or recipient information is not available through the social networking system, as shown in FIG. 4. Block S160 can also delay sender entry of payment information until the gift is confirmed or accepted by the recipient, such as described in U.S. application Ser. No. 13/615,289, which is incorporated in its entirety by this reference.

Block S160 can also prompt the sender to customize the gift, such as shown in FIG. 5 and described in U.S. application Ser. No. 13/615,289. For example, Block S160 can prompt the sender to select a color, size, configuration, form, engraving, etc. for the gift while the sender is completing the gift order. Block S160 can also prompt the sender to complete a card, made out to the user, to accompany the gift when delivered to the recipient. However, Block S160 can function in any other way to direct the sender to purchase the gift for the recipient.

As shown in FIGS. 4 and 6, one variation of the method S100 further includes Block S170, which recites initiating delivery of the gift to the recipient. In one example, for the gift that is a virtual product, Block S170 delivers the gift to the recipient's social network profile. In another example, for the gift that is a tangible product, Block S170 transmits gift order details, such as item SKU number, quantity, payment information, and destination, to an order fulfillment service (e.g., Amazon.com), wherein the order fulfillment service fulfills the order by shipping the gift to the recipient. In yet another example, for the gift that is a redeemable coupon for an experience, Block S170 delivers the coupon to an email address linked to the recipient's social network profile. However, Block S170 can function in any other way to initiate delivery of the gift to the recipient.

As shown in FIGS. 4 and 6, one variation of the method S100 includes Block S180, which recites transmitting the note to the recipient from within the social networking system. In one example, once the sender completes the gift order for the gift, completes the note, and selects a “Send” button, Block S180 delivers the note, through the social networking system, to the recipient's social network profile. In another example, once the sender selects the gift, completes the note, and selects a “Send” button, Block S180 delivers the note, through the social networking system, to the recipient's social network profile, wherein transmission of the note completes the gift order and triggers delivery of the gift to the recipient in Block S170. Block S180 can also attach notification of the gift order to the note such that the recipient can review the gift with the sender's note. Alternatively, such as in the implementation in which the gift is a virtual product, Block S180 can cooperate with Block S170 to bundle the gift with the note and to deliver the note and gift set to the recipient. Block S180 can alternatively transmit the note, from the sender, to the recipient via any other suitable communication pathway, such as email, SMS text message, notification on a mobile computing device, postal letter, etc. However, Block S180 can function in any other way to transmit the note to the recipient.

In one variation, the method S100 implements one or more of the foregoing techniques and/or functionalities to determine an upcoming event of the recipient, to select a gift, and to notify a sender of the upcoming event such that the sender can provide a gift to the recipient on time for the event. For example, the method S100 can determine that the user is schedule to take a standardized test on the following Saturday, such as by accessing a calendar of the recipient or by analyzing a post by the recipient within the social networking system and identifying a cue of an upcoming event. Based on this extracted information suggestive of the upcoming event, the method can select a recommended gift for the recipient, incorporate a recommendation for the gift into a notification, and deliver the notification to the sender while the sender drafts a note to the recipient prior to the event. However, the method S100 can function in any other way to achieve any other suitable functionality pertaining to recommending a gift to a sender prior to a gift-appropriate event, during a gift-appropriate event, and/or succeeding a gift-appropriate event.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
receiving a set of communications from a set of users, the set of communications directed to a recipient through a social networking system;
identifying a gift-appropriate event of the recipient based on the set of communications;
determining an intent of a sender to respond to the gift-appropriate event of the recipient based on an incomplete electronic note drafted by the sender, within the social networking system, and designating the recipient;
selecting a gift for the recipient in response to the determined intent of the sender; and
prior to transmission of the note to the recipient, displaying a recommendation to the sender, the recommendation comprising a suggestion to purchase the selected gift for the recipient.

2. The method of claim 1, wherein displaying a recommendation further comprises modifying the recommendation for the gift prior to submission of a gift order, for the gift, by the sender.

3. The method of claim 2, wherein modifying the recommendation for the gift comprises selecting a second gift for the recipient in response to submission of a gift order for the gift by a second user prior to submission of a gift order for the gift by the sender.

4. The method of claim 1, wherein identifying the gift-appropriate event of the recipient comprises implementing natural language processing of textual communications directed to a social network profile of the recipient to identify the gift-appropriate event.

5. The method of claim 1, wherein identifying the gift-appropriate event of the recipient further comprises confirming the gift-appropriate event through analysis of personal information entered by the recipient into the social networking system.

6. The method of claim 1, wherein determining the intent of the sender comprises matching an incomplete phrase entered into the note by the sender with a template phrase associated with a gift-appropriate event.

7. The method of claim 1, wherein selecting the gift comprises identifying an interest of the recipient based on personal information entered into the social networking system by the recipient and selecting the gift based on the identified interest of the recipient.

8. The method of claim 1, wherein selecting the gift comprises identifying a second gift sent to the recipient by a second user and selecting the gift that is other than the second gift.

9. The method of claim 1, wherein selecting the gift comprises selecting the gift based on at least one of a demographic of the recipient, a demographic of the sender, and the identified relationship between the sender and the recipient.

10. The method of claim 1, wherein selecting the gift comprises determining a location of the recipient through a digital multimedia device carried by the recipient and selecting the gift based on proximity of the recipient to a merchant.

11. The method of claim 1, wherein displaying the recommendation to the sender comprises displaying the recommendation adjacent an input field containing the note drafted by the sender.

12. The method of claim 1, further comprising directing the sender to purchase the gift for the recipient by displaying a check box adjacent the recommendation and confirming a gift order by the sender based on selection of the check box and subsequent transmission of the note to the recipient.

13. The method of claim 1, further comprising transmitting the note to the recipient from within the social networking system.

14. The method of claim 1, further comprising initiating delivery of the gift to the recipient.

15. A method comprising:
identifying a gift-appropriate event of a recipient based on an incomplete textual electronic note drafted by the sender, the electronic note entered into a social networking system and designating the recipient;
determining an intent of the sender to respond to the gift-appropriate event based on the electronic note;
selecting a gift for the recipient in response to the determined intent of the sender; and
prior to transmission of the note to the recipient, displaying a recommendation to the sender, the recommendation comprising a suggestion to purchase the gift for the recipient.

16. The method of claim 15, wherein identifying the gift-appropriate event of the recipient and confirming the gift-appropriate event comprise implementing natural language processing of the incomplete note drafted by the sender and the communication sent by the second user, respectively.

17. The method of claim 15, wherein identifying the gift-appropriate event of the recipient further comprises confirming the gift-appropriate event through analysis of personal information entered by the recipient into the social networking system.

18. The method of claim 17, wherein selecting the gift for the recipient comprises identifying an interest of the recipient based on personal information entered into the social networking system by the recipient and selecting the gift based on the identified interest of the recipient.

19. The method of claim 15, further comprising directing the sender to purchase the gift for the recipient by displaying an input field adjacent the recommendation and confirming a gift order by the sender based on a sender input into the input field and subsequent transmission of the note to the recipient.

20. The method of claim 15, further comprising confirming the gift-appropriate event of the recipient based on a communication directed to the recipient, from a second user, within the social networking system.

21. A method comprising:
identifying a gift-appropriate event of a recipient based on personal information entered, by the recipient, into a social networking system;
determining an intent of a sender to respond to the gift-appropriate event of the recipient based on an incomplete textual electronic note drafted by the sender, the electronic note entered into the social networking system and designating the recipient;
selecting a gift for the recipient in response to the determined intent of the sender; and
prior to transmission of the note to the recipient, displaying a recommendation to the sender, the recommendation comprising a suggestion to purchase the gift for the recipient.

22. The method of claim 21, further comprising confirming the gift-appropriate event of the recipient based on a communication directed to the recipient, from a second user, within the social networking system.
